(19) United States
(12) Patent Application Publication
(10) Pub. No.: US 2016/0064815 A1
(43) Pub. Date: Mar. 3, 2016

(54) ANTENNA EQUIPPED WITH HORIZONTALLY ARRANGED RADIATING ELEMENTS

(71) Applicant: KMW Inc., Gyeonggi-Do (KR)

(72) Inventors: Young-Chan Moon, Gyeonggi-Do (KR); Sung-Hwan So, Gyeonggi-Do (KR); In-Ho Kim, Gyeonggi-Do (KR); Oh-Seog Choi, Gyeonggi-Do (KR)

(73) Assignee: KMW Inc.

(21) Appl. No.: 14/845,880

(22) Filed: Sep. 4, 2015

Related U.S. Application Data
(63) Continuation of application No. PCT/KR2014/001812, filed on Mar. 5, 2014.

(30) Foreign Application Priority Data
Mar. 6, 2013 (KR) 10-2013-0024050

(51) Int. Cl. H01Q 3/18

(52) U.S. Cl. CPC H01Q 3/18

(57) ABSTRACT

The present invention relates to a base station antenna for mobile communication, the antenna, equipped with horizontally arranged radiating elements and connected to a base station system, comprising: a reflective plate disposed in the interior of a multiple-input multiple-output antenna; a plurality of antennas disposed on the planar surface of the reflective plate; and a moving unit for moving the plurality of antennas vertically within the range of the planar surface of the reflective plate.

### CROSS REFERENCE TO RELATED APPLICATIONS

This application is a continuation of International Application No. PCT/KR2014/001812 filed on Mar. 5, 2014, which claims priority to Korean Application No. 10-2013-0024050 filed on Mar. 6, 2013, which applications are incorporated herein by reference.

### TECHNICAL FIELD

The present invention relates to a base station multi-antenna for mobile communication and, more specifically, to an antenna equipped with horizontally arranged radiating elements that can adjust the horizontal arrangement of the radiating elements thereof.

### BACKGROUND ART

In recent years, techniques for processing higher-capacity data at a high speed have been required with the development of mobile communication technology. To this end, base stations have been additionally installed in places that attract a lot of people to thereby increase the capacities for calls and data processing. However, the additional installation of the new base stations encounters a limitation of space and causes an installation cost.

In cases where base stations are additionally installed in order to process mobile phone calls and data in places that attract a lot of people for a specific time, the processing capacities of the additionally installed base stations are unnecessary after the specific time that many people gather. For example, office workers in the city gather in specific areas during working hours and scatter after the working hours. That is, people tend to be excessively concentrated in a place only at specific times. Accordingly, a technology by which existing base stations can process more mobile phone calls and data without additional base stations is required in mobile communication antenna markets.

Multi-antenna techniques have been developed to solve this problem. For example, multi input multi output (MIMO), one of the multi-antenna techniques, is a technique for increasing the capacities for mobile phone communication and data processing by installing multi-antennas at transmission and reception sides. A single multi-antenna having a plurality of antennas therein simultaneously transmits independent wireless signals, and divides the same area and manages it, thereby increasing the capacities for mobile phone calls and data processing. This helps to configure such an environment as operating multiple base stations in the same space, which leads to an increase in capacity for mobile phone calls and data processing. In addition, the MIMO technique can be applied to both mobile base stations and fixed base stations that serve long term evolution (LTE) networks and wideband code division multiple access (WCDMA) networks.

Antennas developed in response to the requirement have been designed to operate in a broad band. However, radiating elements thereof are horizontally arranged at moderate intervals, not optimal intervals so that the radiating elements fail to optimally operate in actual frequencies.

Accordingly, in order to solve the aforementioned problems, a technology is required in which an antenna receives information on a frequency environment of the installation area thereof from a base station and adjusts the horizontal arrangement of radiating elements thereof by itself in order to achieve optimal antenna performance in the installed frequency environment.

(Patent Document 1) Korean Patent Application No. 10-2003-0027727 (filed on Apr. 30, 2003 and entitled “Antenna system for controlling horizontal beam and vertical beam of antenna radiation pattern and control method for antenna system using same”; inventors Hyo-Jin Lee and Sang-Gi Kim; applicants LG Telecom, Ltd. and Gamma Nu, Inc.)

### SUMMARY

An aspect of the present invention is to provide an antenna equipped with horizontally arranged radiating elements that can control the horizontal arrangement of the radiating elements thereof.

Another aspect of the present invention is to provide an antenna equipped with horizontally arranged radiating elements that can group the radiating elements on a column basis and uniformly control the horizontal arrangement of the radiating elements thereof.

Another aspect of the present invention is to provide an antenna equipped with horizontally arranged radiating elements that can individually control the horizontal arrangement of the radiating elements thereof.

In accordance with one aspect of the present invention, an antenna equipped with horizontally arranged radiating elements, which is connected to a base station system, includes: a reflective plate installed in the interior of the antenna; a plurality of radiating elements installed on a planar surface of the reflective plate; and a moving unit that moves the plurality of radiating elements leftwards or rightwards on the planar surface of the reflective plate.

The antenna may further include: an antenna state detector that detects the state of the connection with the base station system and the operating state of the antenna, and creates antenna information; a radio frequency signal detector that measures the strength of a radio frequency signal currently being provided in the area where the antenna has been installed, and creates radio frequency signal information and frequency band information; a controller that creates interval control information; and an interval adjustment driving unit that adjusts the intervals between the plurality of radiating elements in a left-right direction according to the interval control information.

The interval control information may be created using service band information received from the base station system or the frequency band information.

Based on at least one of the plurality of radiating elements, the moving unit may move the remaining radiating elements leftwards or rightwards.

The base station antenna may move the plurality of radiating elements leftwards or rightwards with respect to the vertical center line of the reflective plate.

Among the plurality of radiating elements, the radiating elements, other than the leftmost or rightmost radiating element, may be moved leftwards or rightwards.

Two or more of the plurality of radiating elements may be simultaneously moved leftwards or rightwards, or the radiating elements may be individually moved leftwards or rightwards.

### BRIEF DESCRIPTION OF THE DRAWINGS

FIG. 1 is a block diagram of an antenna that includes horizontally arranged radiating elements according to an embodiment of the present invention;

FIG. 2 is a schematic diagram illustrating an exemplary structure of a moving unit of an antenna that includes horizontally arranged radiating elements, according to an embodiment of the present invention;

FIG. 3 is a schematic diagram illustrating an exemplary operation of the antenna that includes the horizontally arranged radiating elements, according to an embodiment of the present invention; and

FIGS. 4A and 4B illustrate horizontal beam forming simulation results for an exemplary operation of an antenna including horizontally arranged radiating elements, according to an embodiment of the present invention.

### DETAILED DESCRIPTION

Hereinafter, an exemplary embodiment of the present invention will be described in detail with reference to the accompanying drawings. Although particular matters such as specific configuration elements are shown in the following description, it will be obvious to those skilled in the art to which the present invention pertains that the particular matters are provided only to help a comprehensive understanding of the present invention, and various modifications and changes can be made within the scope of the present invention.

Further, in the accompanying drawings and the following description, identical elements are provided with the same reference numeral where possible.

An antenna that will be described below includes a plurality of radiating elements capable of supporting broadband frequencies.

In an embodiment of the present invention, a method of grouping the plurality of radiating elements on a column basis and moving the radiating element groups leftwards or rightwards will be described as an example of a method of adjusting the intervals of the plurality of radiating elements.

In descriptions of an antenna that includes horizontally arranged radiating elements, according to an embodiment of the present invention, in respect to a MIMO antenna, the radiating elements grouped on a column basis may be defined as independent antennas, and the antenna may be described as a MIMO antenna that includes the plurality of independent antennas.

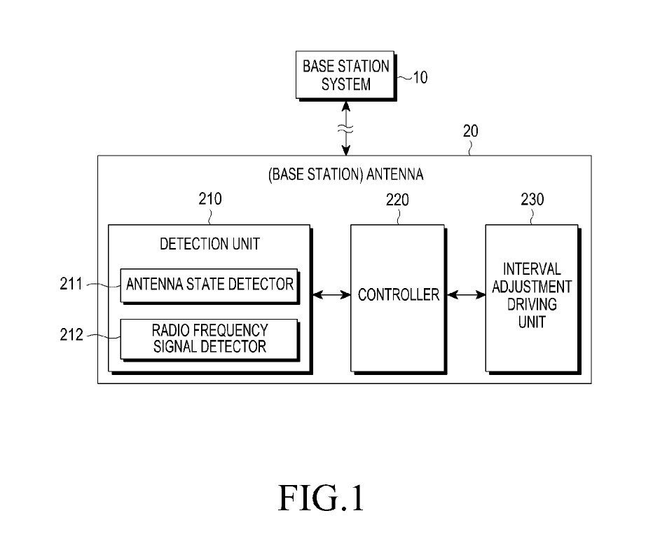

FIG. 1 is a block diagram of an antenna that includes horizontally arranged radiating elements according to an embodiment of the present invention.

The antenna which includes the horizontally arranged radiating elements, according to the embodiment of the present invention, is a base station antenna 20 connected to a base station system 10 equipped with broadband communication devices.

The base station system 10 refers to a wireless communication base station of a mobile communication service provider, and may be equipped with various bands of communication devices. Here, examples of the various bands include the 800 MHz band or the 900 MHz band (e.g., 698 to 960 MHz) which is a relatively low frequency band, or the 1.8 MHz band or the 2.1 GHz band (e.g., 1.7 to 2.17 GHz) or the 2.3 GHz band (e.g., 2.3 to 2.7 GHz) which is a relatively high frequency band.

The base station system 10 provides information on a service band of an area where the base station antenna 20 has been installed to a controller 220 included in the base station antenna 20, which will be described below.

The base station system 10 receives, from the base station antenna 20, antenna status information that contains information necessary for identifying whether the base station antenna 20 has been normally connected with the base station system 10 through a wired line, a wireless line, or a combination of wired and wireless lines.

The base station system 10 may receive, from the base station antenna 20, antenna status information containing information necessary for identifying whether the normally connected base station antenna 20 normally operates as a service band corresponding to a service area in the installation area thereof.

The base station antenna 20 is an antenna supporting a broadband and is always connected with the base station system 10 through a wired line, a wireless line, or a combination of wired and wireless lines.

The base station antenna 20 receives service band information of the installation area thereof from the base station system 10.

In cases where the base station antenna 20 fails to receive the service band information of the installation area thereof from the base station system 10, the base station antenna 20 acquires the service band information of the current installation area thereof by itself through a radio frequency (RF) signal detector 212 included in a detection unit 210, which will be described below.

The base station antenna 20 includes the detection unit 210 for detecting the state of the antenna, the controller 220 for controlling the antenna to operate at an optimal performance, and an interval adjustment driving unit 230 for adjusting intervals between the plurality of radiating elements horizontally arranged in the broadband antenna.

The detection unit 210 includes an antenna state detector 211 and the radio frequency signal detector 212.

The antenna state detector 211 performs functions of detecting the overall connection state and operating state of the base station antenna 20 and transferring the detection results to the controller 20. Here, the functions of detecting the connection state and the operating state may be defined as follows.

The function of detecting the connection state means a function of detecting whether the base station antenna 20 and the base station system 10 have been normally connected to each other and providing the corresponding information to the controller 220, which will be described below.

The function of detecting the operating state means a function of detecting whether the elements constituting the base station antenna 20 operate normally and providing the corresponding information to the controller 220.

The radio frequency signal detector 212 detects service band information currently being provided in the area where the base station antenna 20 has been installed and provides the detected information to the controller 220.

The base station antenna 20 measures a radio frequency signal in a service band currently being used, and provides the measured RF signal strength to the controller 220.

The controller 220 processes various types of information to provide a service at optimal performance in the service band corresponding to the area where the base station antenna 20 has been installed.

In order to provide service at an optimal performance, the controller 220 receives information on the service band corresponding to the installation area from the base station system 10, and provides optimized interval adjustment control information to the interval adjustment driving unit 230 in the corresponding service band extracted from the received information.

In cases where the controller 220 fails to receive the information on the service band from the base station system 10, the controller 220 makes a request for information on a service band in which a service is currently provided through the base station antenna 20 to the radio frequency signal detector 212 included in the detection unit 210 to receive the information, and calculates optimized interval adjustment control information for the corresponding service band from the received information to provide the calculated information to the interval adjustment driving unit 230.

The interval adjustment driving unit 230 adjusts the intervals between the plurality of radiating elements, which are horizontally arranged in the broadband antenna, according to the interval adjustment control information received from the controller 220.

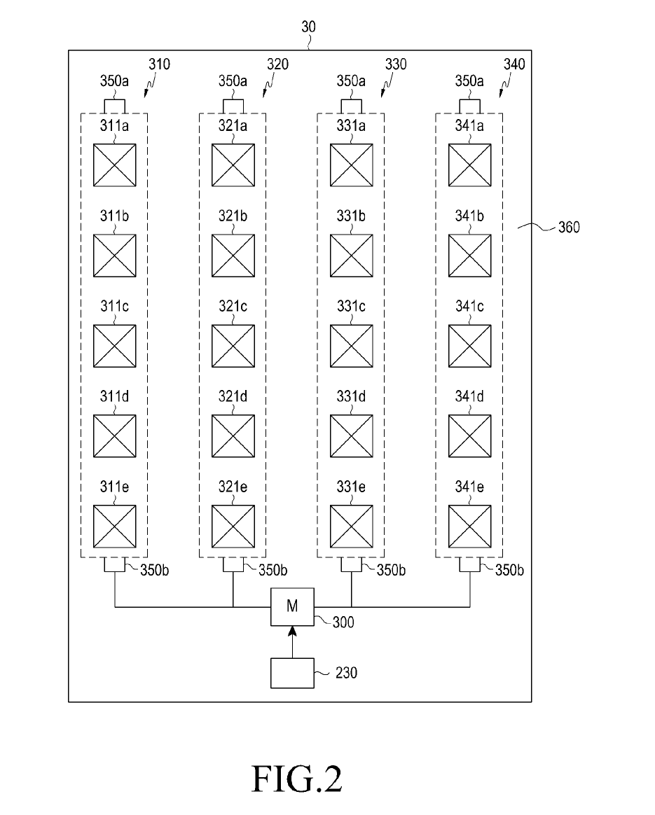

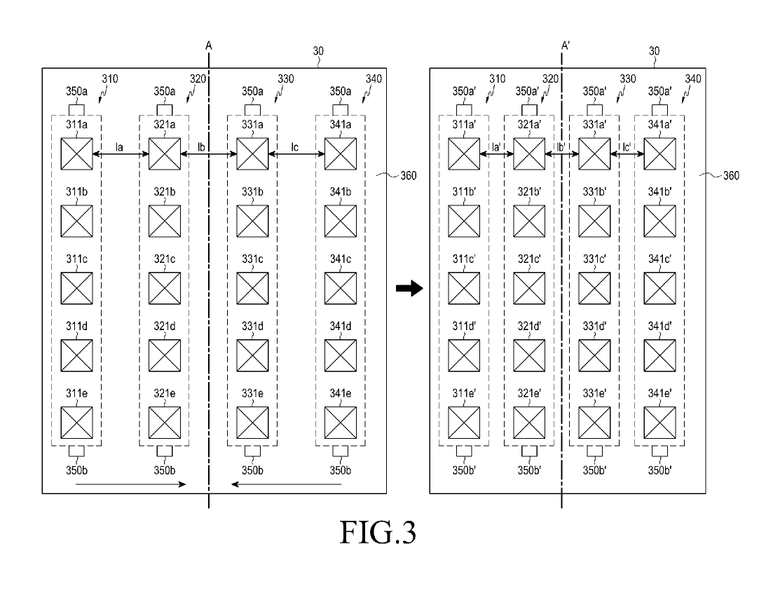

FIG. 2 is a schematic diagram illustrating an exemplary structure of a moving unit of an antenna that includes horizontally arranged radiating elements, according to an embodiment of the present invention, and FIG. 3 is a schematic diagram illustrating an exemplary operation of the antenna that includes the horizontally arranged radiating elements, according to an embodiment of the present invention.

Referring to FIG. 2, a moving unit 30 includes a reflective plate 360, a plurality of radiating element columns 310, 320, 330, and 340 horizontally arranged on the reflective plate 360, a moving support part 350 (350a and 350b) provided on upper and lower ends of each of the plurality of radiating element columns 310, 320, 330, and 340, a power generation unit 300 (e.g., a motor) for supplying power for interval adjustment, and the interval adjustment driving unit 230 for controlling the power generation unit 300 according to interval adjustment control information.

The plurality of radiating element columns 310, 320, 330, and 340, which are horizontally arranged, include a plurality of radiating elements 311, 321, 331, and 341 to form a single broadband antenna.

Further, the plurality of radiating element columns 310, 320, 330, and 340 are horizontally arranged on the reflective plate 360 to form a multi-antenna that can be applied to MIMO technique.

The moving support parts 350 (350a and 350b) make the plurality of radiating element columns 310, 320, 330, and 340 easily move leftwards or rightwards, and secure the plurality of radiating element columns 310, 320, 330, and 340 to the reflective plate 360 when the intervals between the radiating element columns are completely adjusted.

The power generation unit 300 is connected to the plurality of radiating element columns 310, 320, 330, and 340 or the moving support parts 350 (350a and 350b) through a rack and pinion gear, a link structure, various gear connection structures, a guide and slide structure, etc. to supply power for the interval adjustment.

Referring to FIG. 3, the plurality of radiating element columns 310, 320, 330, and 340 are classified into the left-side antennas 310 and 320 and the right-side antennas 330 and 340 based on the virtual vertical center line A of the reflective plate 360 when the intervals therebetween are adjusted.

During the interval adjustment, the interval adjustment driving unit 230 controls the power generation unit 300, according to interval adjustment control information, to adjust the intervals between the plurality of radiating element columns 310, 320, 330, and 340, which are installed in the horizontal array on the reflective plate 360.

Here, the intervals between the plurality of radiating element columns 310, 320, 330, and 340 may be decreased, or may be alternatively increased. The plurality of radiating element columns may be classified into the left-side radiating element columns and the right-side radiating element columns based on a vertical line of the reflective plate 360 in addition to the vertical center line A, and the left-side and right-side radiating element columns may be moved leftwards or rightwards for the adjustment of the intervals therebetween.

Based on one of the plurality of radiating element columns 310, 320, 330, and 340 horizontally arranged on the reflective plate 360, the remaining radiating element columns may be horizontally moved for the adjustment of the intervals therebetween.

In cases where the intervals between the plurality of radiating element columns 310, 320, 330, and 340 are reduced as illustrated in FIG. 3, the vertical center line A of the reflective plate 360 is set to be a reference for the adjustment of the intervals therebetween. The intervals may be reduced by moving the radiating element columns 310 and 320 on the left side of the virtual vertical center line A rightwards and moving the radiating element columns 330 and 340 on the right side of the virtual vertical center line leftwards. Here, it can be identified that the intervals 1a′, 1b′, 1c′, and 1d′ between the radiating element columns after the interval adjustment are smaller than the intervals 1a, 1b, 1c, and 1d between the radiating element columns before the interval adjustment.

In contrast, in cases where the intervals between the plurality of radiating element columns 310, 320, 330, and 340 are increased, the radiating element columns 310 and 320 on the left side of the vertical center line A may be moved leftwards, and the radiating element columns 330 and 340 on the right side of the vertical center line A may be moved rightwards.

Although the plurality of radiating element columns 310, 320, 330, and 340 are horizontally arranged with respect to the center of the reflective plate 360 in FIGS. 2 and 3, the present invention is not limited thereto, and even if the plurality of radiating element columns 310, 320, 330, and 340 are horizontally arranged in any place of the reflective plate 360, the intervals between the radiating element columns 310, 320, 330, and 340 may be adjusted while one of the plurality of radiating element columns 310, 320, 330, and 340 is selected to be a reference. For example, in cases where the intervals between the plurality of radiating element columns 310, 320, 330, and 340 are increased with respect to the leftmost radiating element column 310 among the plurality of radiating element columns 310, 320, 330, and 340 installed on the reflective plate 360, the intervals between the plurality of radiating element columns 310, 320, 330, and 340 may be increased by moving the radiating element columns 320, 330, and 340 rather than the reference radiating element column 310 rightwards. In contrast, in cases where the intervals between the plurality of radiating element columns 310, 320, 330, and 340 are reduced with respect to the radiating element column 310, the intervals between the plurality of radiating element columns 310, 320, 330, and 340 may be reduced by moving the radiating element columns 320, 330, and 340 rather than the reference radiating element column 310 leftwards.

Further, in cases where the intervals between the plurality of radiating element columns 310, 320, 330, and 340 are increased with respect to the rightmost radiating element column 340 among the plurality of radiating element columns 310, 320, 330, and 340 installed on the reflective plate 360, the intervals between the plurality of radiating element columns 310, 320, 330, and 340 may be increased by moving the radiating element columns 310, 320, and 330 rather than the reference radiating element column 340 leftwards. In contrast, in cases where the intervals between the plurality of radiating element columns 310, 320, 330, and 340 are reduced with respect to the radiating element column 340, the intervals between the plurality of radiating element columns 310, 320, 330, and 340 may be reduced by moving the radiating element columns 310, 320, and 330 rather than the reference radiating element column 340 rightwards.

Although the plurality of radiating element columns 310, 320, 330, and 340, which are horizontally arranged, are all controlled at one time in the above described method of adjusting the intervals between the radiating element columns 310, 320, 330, and 340, the present invention is not limited thereto, and the intervals between the radiating element columns 310, 320, 330, and 340 may be adjusted by individually moving the radiating element columns leftwards or rightwards, or by selecting one or more of the plurality of radiating element columns 310, 320, 330, 340 and then simultaneously moving the selected radiating element columns leftwards or rightwards.

The horizontal arrangement of the plurality of radiating elements 311, 321, 331, and 341 can be adjusted by moving the radiating elements leftwards or rightwards through the adjustment of the intervals between the plurality of radiating element columns 310, 320, 330, and 340, or by selecting one or more of the plurality of radiating elements 311, 321, 331, and 341 and then simultaneously moving the selected radiating elements leftwards or rightwards. This is because each radiating element column can be accurately controlled according to a selection of the base station system or the controller included in the base station antenna after the intervals between the radiating element columns are uniformly adjusted.

Through the interval adjustment described above, the multi-antenna can achieve the best performance in a frequency band currently being used in the area where the multi-antenna has been installed. This is because the multi-antenna can achieve performance specialized for service frequencies in a specific band as the intervals between the plurality of radiating elements 311, 321, 331, and 341 installed in the horizontal array form in the multi-antenna are increased or decreased.

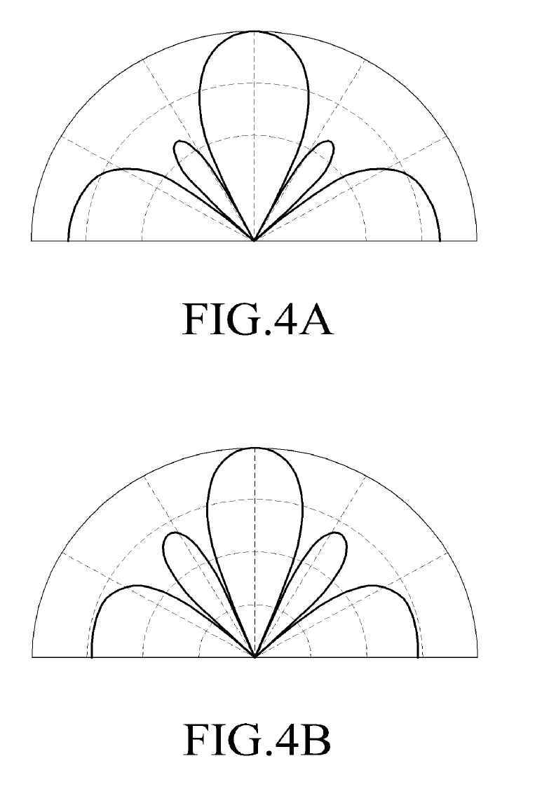

FIGS. 4A and 4B illustrate horizontal beam forming simulation results for an exemplary operation of an antenna including horizontally arranged radiating elements, according to an embodiment of the present invention.

As a result, among beam characteristics of the base station antenna to which the antenna containing horizontally arranged radiating elements, according to the present invention, is applied, side-lobe is adjusted through the adjustment of the intervals between the plurality of the radiating elements 311, 321, 331, and 341.

FIG. 4A is a horizontal beam forming simulation result in which the plurality of radiating elements 311, 321, 331, and 341 are horizontally arranged at an interval of 1.1λ, and FIG. 4B is a horizontal beam forming simulation result in which the plurality of radiating elements 311, 321, 331, and 341 are horizontally arranged at an interval of 1.3λ. It can be seen that the side-lobe in the horizontal beam forming simulation result of FIG. 4A is better than that of FIG. 4B. Therefore, the plurality of radiating elements 311, 321, 331, and 341 can achieve optimal performance when the intervals therebetween are properly adjusted to be suitable for the frequencies being used.

Although a conventional multi-antenna cannot provide an optimal service when installed in an area with a frequency environment in which a macro base station and small base stations are intermingled with each other, the antenna containing the horizontally arranged radiating elements, according to the present invention, can enhance the beam efficiency of each broadband antenna included in the multi-antenna while minimizing interference between the base stations even if being installed in the area having the above-described frequency environment.

In addition, the multi-antenna according to the present invention can improve a data transmission rate and high-capacity data transmission by reducing antenna interference, compared to the conventional multi-antenna.

The antenna equipped with horizontally arranged radiating elements, according to the embodiment of the present invention, can control the horizontal arrangement of the radiating elements thereof to adjust side-lobe among beam characteristics of the antenna, thereby achieving beam efficiency for minimizing interference between a macro base station and small base stations that are intermingled with each other.

Furthermore, even if a frequency environment around the area where the antenna has been installed changes, the antenna can adapt to the changed frequency environment to achieve optimal performance by controlling the horizontal arrangement of the radiating elements thereof.

Although the present disclosure has been described with reference to the embodiments shown in the drawings, it should be understood by those skilled in the art that various changes and modifications may be made thereto and other embodiments equivalent thereto are possible. Accordingly, the scope of the present disclosure is not limited to the above-described embodiments and should be determined by the appended claims and their equivalents.

What is claimed is:

1. An antenna equipped with horizontally arranged radiating elements, which is connected to a base station system, comprising:
a reflective plate installed in the interior of the antenna;
a plurality of radiating elements installed on a planar surface of the reflective plate; and
a moving unit that moves the plurality of radiating elements leftwards or rightwards on the planar surface of the reflective plate.

2. The antenna of claim 1, further comprising:
an antenna state detector that detects the state of the connection with the base station system and the operating state of the antenna and creates antenna information;
a radio frequency signal detector that measures the strength of a radio frequency signal currently being provided in the area where the antenna has been installed, and creates radio frequency signal information and frequency band information;
a controller that creates interval control information; and
an interval adjustment driving unit that adjusts the intervals between the plurality of radiating elements in a left-right direction according to the interval control information.

3. The antenna of claim 2, wherein the interval control information is created using service band information received from the base station system or the frequency band information.

4. The antenna of claim 1, wherein based on at least one of the plurality of radiating elements, the moving unit moves the remaining radiating elements leftwards or rightwards.

5. The antenna of claim 1, wherein the antenna moves the plurality of radiating elements leftwards or rightwards with respect to the vertical center line of the reflective plate.

6. The antenna of claim 4, wherein among the plurality of radiating elements, the radiating elements other than the leftmost or rightmost radiating element are moved leftwards or rightwards.

7. The antenna of claim 4, wherein two or more of the plurality of radiating elements are simultaneously moved leftwards or rightwards, or the radiating elements are individually moved leftwards or rightwards.
